(19) United States
(12) Patent Application Publication
(10) Pub. No.: US 2021/0285450 A1
(43) Pub. Date: Sep. 16, 2021

(54) TRUCK-MOUNTED CONCRETE PUMP

(71) Applicant: Liebherr-Mischtechnik GmbH, Bad Schussenried (DE)

(72) Inventors: Raphael SEIFRIED, Ulm (DE); Johannes FETZER, Nersingen (DE); Karl WESTERMANN, Bad Urach (DE)

(21) Appl. No.: 17/197,984

(22) Filed: Mar. 10, 2021

(30) Foreign Application Priority Data
Mar. 16, 2020 (DE) 20 2020 101 432.3
Jan. 8, 2021 (DE) 10 2021 100 204.4

(51) Int. Cl. F04D 13/02; B60P 3/16; F04D 13/06

(52) U.S. Cl. CPC F04D 13/021; F04D 13/06; B60P 3/16

(57) ABSTRACT

The invention relates to a truck-mounted concrete pump having at least one travelling-drive motor and a hydraulic pumping device for delivering liquid concrete, wherein at least one electric motor is provided and the hydraulic pumping device can be driven either by the at least one travelling-drive motor or the at least one electric motor, characterized in that the travelling-drive motor is connected by way of a power take-off of a transfer gearbox of the travelling-drive train of the truck-mounted concrete pump to a branching gearbox, with a first gearbox input of the branching gearbox being coupled with the power take-off of the travelling-drive motor and a second gearbox input being coupled with the electric motor, and the gearbox output of the branching gearbox being connected to at least one hydraulic pump of the hydraulic pumping device.

### CROSS REFERENCE TO RELATED APPLICATIONS

The present application claims priority to German Patent Application No. 20 2020 101 432.3 filed on Mar. 16, 2020 and German Patent Application No. 10 2021 100 204.4 filed on Jan. 8, 2021. The entire contents of the above-listed applications are hereby incorporated by reference for all purposes.

### TECHNICAL FIELD

The invention relates to a truck-mounted concrete pump having at least one travelling-drive motor and a hydraulic pumping device.

### BACKGROUND AND SUMMARY

Truck-mounted concrete pumps as a rule consist of a commercial lorry chassis with an attachment unit—typically consisting of a concrete pump, a supporting device and a concrete distributor boom—placed on top. Power is usually supplied to all the drives of this attachment unit hydraulically by a hydraulic pumping device. This pumping device as a rule comprises one or more hydraulic pumps, which supply at least one hydraulically-driven pumping cylinder, in order to deliver fresh concrete to the desired location by way of a distributor boom. Further hydraulic pumps or other hydraulic consumers, for example for adjusting the boom, may likewise be a component of the pumping device.

Generic truck-mounted concrete pumps usually operate with diesel-hydraulic drives, i.e. the diesel engine of the commercial lorry chassis which serves as a carrier vehicle for travel mode drives the hydraulic pumping device on the construction site during stationary pumping operation. The resulting noise and exhaust emissions are undesirable particularly in the case of urban construction sites.

The object of the present invention therefore consists in developing a truck-mounted concrete pump without technically changing the commercial lorry chassis which serves as a carrier vehicle, such that in particular the unwanted diesel exhaust is not produced upon stationary pump operation.

This object is achieved by a truck-mounted concrete pump according to the features of claim 1. Advantageous embodiments of the truck-mounted concrete pump are the subject of the dependent claims.

According to the invention, it is proposed to equip the truck-mounted concrete pump additionally with an electric motor. However, it is not a purely electrical-hydraulic drive of the hydraulic pumping device which is to be implemented, but according to the invention an option is provided for driving the hydraulic pumping device either by means of the electric motor or alternatively by means of the inbuilt travelling-drive motor. The travelling-drive motor may be in particular an internal combustion engine or a diesel engine. For simplicity, in the following an internal combustion engine will predominantly be assumed to be the travelling-drive motor, but the following statements apply equally with regard to an alternative embodiment of the travelling-drive motor. For example, it might be formed by a further electric travelling-drive motor.

The structure of the truck-mounted concrete pump comprises a commercial lorry chassis, on which an attachment unit consisting of a hydraulic pumping device and preferably a concrete distributor boom is placed. Power is supplied to some or all of the drives of this attachment unit hydraulically by means of one or more hydraulic pumps.

The travelling-drive motor of the truck-mounted concrete pump corresponds to the travelling drive of the commercial lorry chassis, and driving takes place by way of a torque-transmitting mechanical connection between the travelling-drive motor and the drive axle or axles of the commercial lorry chassis, preferably a cardan shaft. The hydraulic pumping device is to be understood to mean at least a part of the hydraulic system for the pumping operation. This includes for example at least one hydraulic pump for providing the hydraulic power supply and also at least one hydraulically-driven pumping unit for delivering the liquid concrete, for example in the form of a pumping cylinder. Further hydraulic pumps may be provided in order to feed any secondary consumers, for example also a hydraulic actuator means for adjusting the distributor boom of the concrete pump.

Primarily, the truck-mounted concrete pump, in particular the hydraulic pumping device, in stationary pumping operation is to be operated by the electric motor. As a result, emission of the undesirable diesel exhaust can be avoided. If need be, i.e. if the electricity necessary for operating the electric motor is lacking, for example because the construction site lacks the necessary mains infrastructure, alternatively it should be possible to switch to an inbuilt internal combustion engine of the truck-mounted concrete pump, in particular of the carrier vehicle. The hydraulic pumping device, in particular at least one hydraulic pump, should consequently be able to be driven either by an internal electric motor or alternatively by an internal travelling-drive motor/internal combustion engine of the truck-mounted concrete pump. When a drive motor is used, the alternative drive variant can preferably remain out of operation, i.e. switched off.

The travelling-drive motor/internal combustion engine used serves primarily for the travelling drive of the truck-mounted concrete pump; in particular, it is a component of the carrier vehicle and is connected to the travelling-drive train for when the vehicle is travelling regularly on the road. The internal combustion engine is for example a diesel generator set.

The supplying of the hydraulic pumping device by means of either the travelling-drive motor/internal combustion engine or the additional installed electric motor is achieved by the interposition of a branching gearbox between the hydraulic system and drive units. Such a branching gearbox has two drive inputs and one output. The internal combustion engine and electric motor are coupled with one input each, whereas the hydraulic pumping device, in particular at least one hydraulic pump, is coupled with the output of the branching gearbox.

The internal combustion engine, as already discussed above, serves as a travelling drive and is connected by way of a transfer gearbox to the travelling-drive train of the truck-mounted concrete pump. The mechanical connection to the branching gearbox for alternative driving of the hydraulic pumping device can be produced by way of a power take-off of the transfer gearbox. The power take-off of the transfer gearbox is preferably an engine-dependent power take-off which is connected directly to the crankshaft of the internal combustion engine. What is important is that with the solution according to the invention the branching gearbox for attaching the at least one hydraulic pump is not integrated in the travelling-drive train, but instead with the power take-off of the motor or the motor-side transfer gearbox. Since a ready-produced, commercial lorry vehicle chassis with an already-existing travelling-drive train is regularly used for the structure of the concrete pump, which chassis is equipped with the required structure of the concrete pump, the travelling-drive train of the carrier vehicle can remain unchanged by attaching the branching gearbox to the power take-off of the travelling-drive motor of the vehicle chassis.

According to a preferred embodiment, the electric motor and the at least one hydraulic pump are located on separate shafts, as a result of which the power transmission between the electric motor and the at least one hydraulic pump can be interrupted. The internal combustion engine too is preferably located on a separate shaft. The branching gearbox in this case may be embodied as a manual transfer gearbox and comprises for example two switching states, in order to transmit the torque from the first or second input to the output as desired. Of course, an interconnection pattern in which the torques of both inputs are transmitted to the output, i.e. the electric motor and internal combustion engine jointly provide the necessary driving torque for the hydraulic pumping device, is also conceivable. The preferred variant however provides for power transmission to take place exclusively from one input to the output, while the second input is mechanically disengaged.

The arrangement of the hydraulic pump and electric motor on separate shafts additionally has the advantage that the electric motor can be placed flexibly, in particular in relation to the at least one hydraulic pump. As a result, the electric motor can for example be arranged on the same side of the branching gearbox as the at least one hydraulic pump. However, there is no reason not to arrange the electric motor and at least one hydraulic pump on opposite sides of the branching gearbox.

The electric motor used may have an electrical output of at least 80 kW, preferably at least 100 kW, and ideally of approximately 130 kW. Because of the aforementioned flexibility possibility of mounting the electric motor, there are fewer restrictions with respect to motor size, which is why in the present case a comparatively large electric motor with sufficient electrical output can also be built in. The electric motor may be a synchronous motor, in particular a liquid-cooled synchronous motor. An embodiment as a ring motor, which is fitted directly on the shaft, which is to be driven, for example the gearbox input of the branching gearbox, is also conceivable.

The truck-mounted concrete pump may be equipped with an external mains connection in order to enable the electric motor to be supplied from an external mains supply. As a result, the truck-mounted concrete pump can be connected to a stationary construction site mains, in order to be able to tap off sufficient electrical output for the pumping operation. If an electrical construction site mains is not available, the pumping operation can be switched over to the internal combustion engine.

The mains connection of the truck-mounted concrete pump may be realized by a plurality of connection points, as a result of which the necessary energy can be supplied by way of a plurality of power supply lines. For example, the maximum power for the pumping operation can be tapped off by using all the pluggable lines. Using fewer connection points also permits connection to weaker construction site mains supplies with less connecting cable, but then only reduced power is available for the pumping operation. The connection points of the truck-mounted concrete pump may preferably be designed for different or alternatively identical continuous loads. The connection points may be embodied as CEE sockets, in particular 5-pole CEE sockets. What is conceivable is for example a first CEE socket with a maximum continuous load of 63 A at 400 V, while a second CEE socket is designed for a higher maximum continuous load, for example for a continuous load of 125 A at 400 V. In exactly the same way, the connection points can also be adapted to stipulations set out in standards of other countries, for example in the form of “IEC connectors” used in the USA, which comply with the corresponding directives IEC 60309-1 and 60309-2. Here too, different connection points which are designed for different continuous loads, for example for 30 A, 60 A and 100 A at a voltage of between 500 and 600 V AC, are conceivable.

### BRIEF DESCRIPTION OF THE FIGURES

Further advantages and properties of the invention will be discussed below with reference to an example of embodiment illustrated in the drawings, wherein:

FIG. 1 is a schematic side view of the truck-mounted concrete pump according to the invention, and

FIG. 2 is a detail view of the drive train for supplying the hydraulic pump device.

### DETAILED DESCRIPTION

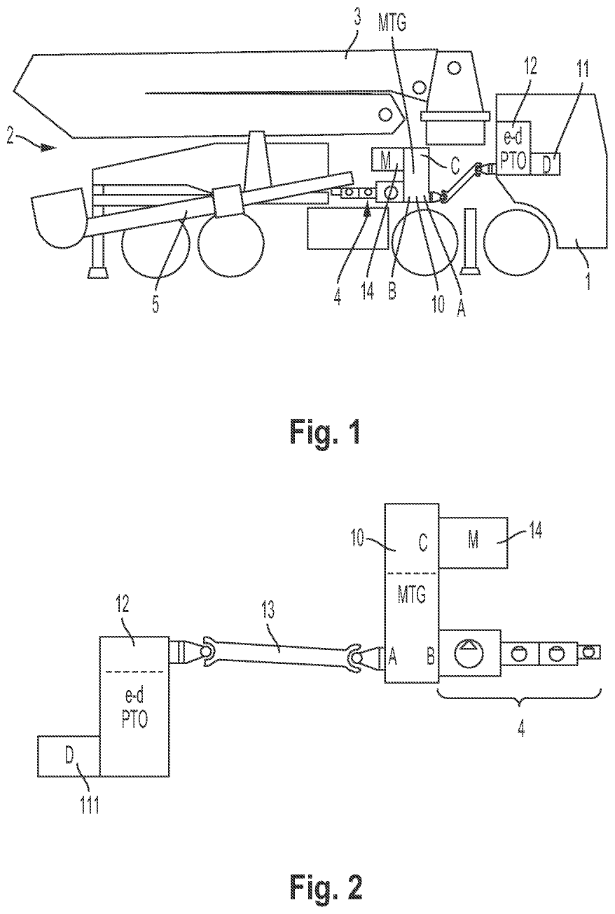

FIG. 1 shows schematically a side view of the truck-mounted concrete pump according to the invention, consisting of a commercial lorry chassis 1 with travelling-drive motor 11 for travel mode, and a superstructure 2, with the hydraulic pumping device, mounted thereon. The superstructure comprises substantially a distributor boom 3 and also the hydraulic pumping device with a plurality of hydraulic pumps 4. The hydraulic pumps 4 ensure, inter alia, the necessary hydraulic pressure for operating the pumping cylinder 5 and also for operating any secondary consumers or actuators for adjusting the distributor boom 3.

As can be inferred in particular from the detail representation in FIG. 2, the hydraulic pumps 4 are coupled jointly with the output B of a manual transfer gearbox 10. This manual transfer gearbox 10 comprises two inputs A, C in addition to the output B. Depending on the switching state of the manual transfer gearbox 10, either the mechanical power applied to the input A or the mechanical power applied to the input C can be switched through to the output B, optionally in conjunction with the necessary transmission ratio.

The first input A is connected by way of a shaft connection 13 to a power take-off of a transfer gearbox 12 of the travelling-drive train of the lorry chassis 1. Flange-mounted on the input of the transfer gearbox 12 there is a diesel generator set 11; the main output of the transfer gearbox 12 is coupled to the further travelling-drive train for the lorry chassis 1 or the truck-mounted concrete pump to travel on the road. Consequently, the diesel generator set 11 of the lorry chassis 1 serves primarily to implement the travel mode of the truck-mounted pump, but at least part of the mechanical power of the diesel generator set 11 can also be used by way of the power take-off of the transfer gearbox 12 for driving the hydraulic pumping device with the pumps 4.

By way of the input C, an electric motor 14 is coupled with the manual transfer gearbox 10. The concept of the truck-mounted concrete pump according to the invention consists in implementing the stationary pumping operation primarily electrically by way of the electric motor 14, and hence in an emission-free manner. The travelling drive of the truck-mounted concrete pump is diesel-powered as hitherto.

The necessary electric power for the electric motor 14 is tapped off from the construction site mains supply by way of a mains connection. In acknowledgement of the frequently-changing construction sites on which a truck-mounted concrete pump can be used, the connection to the construction site mains supply takes place by way of one or more pluggable connections or power supply lines. Using a plurality of pluggable lines to realize the maximum power makes it possible to adapt to weaker construction site mains supplies by using less connecting cable, but then with losses of performance.

Since the construction site mains supplies are currently not designed area-wide for high electrical power consumption, one skillful development of the truck-mounted concrete pump consists in carrying out the travelling drive in principle by diesel engine 11, but making driving of the hydraulic pump train 4 possible either by way of the diesel engine 11 or by way of the electric motor 14 additionally installed.

By means of the invention, a hybrid drive of the attachment unit 2 of the truck-mounted concrete pump is realized which makes fully-electric or diesel-electric driving of the pump hydraulic system possible. The structure according to the invention furthermore permits the use of a commercial lorry chassis 1, on which the attachment unit 2 consisting of the distributor boom 3, the pumping device with the pumps 4 and also the pumping cylinder 5 is placed. The extension of the attachment unit by the manual transfer gearbox 10 and the electric motor permits electric driving of the attachment unit in stationary, non-mobile operation by coupling to the public mains supply.

By attaching the manual transfer gearbox 10 to the power take-off of the lorry travelling-drive train, intervention in the travelling drive of the commercial lorry chassis 1 is not necessary.

The travelling drive of the truck-mounted concrete pump corresponds to the travelling drive of the commercial lorry chassis 1, and driving takes place by way of a torque-transmitting mechanical connection between the travelling-drive motor 11 and the drive axle or axles of the commercial lorry chassis 1, preferably by means of a cardan shaft.

1. A truck-mounted concrete pump having at least one travelling-drive motor and a hydraulic pumping device for delivering liquid concrete, wherein at least one electric motor is provided and the hydraulic pumping device can be driven selectively by the at least one travelling-drive motor or the at least one electric motor, wherein the travelling-drive motor is connected by way of a power take-off of a transfer gearbox of the travelling-drive train of the truck-mounted concrete pump to a branching gearbox, wherein a first gearbox input of the branching gearbox is coupled with the power take-off of the travelling-drive motor and a second gearbox input is coupled with the electric motor, and a gearbox output of the branching gearbox is connected to at least one hydraulic pump of the hydraulic pumping device.

2. The truck-mounted concrete pump according to claim 1, wherein the travelling-drive motor is an internal combustion engine.

3. The truck-mounted concrete pump according to claim 1, wherein the electric motor and the at least one hydraulic pump and/or the travelling-drive motor are each located on separate shafts, as a result of which a power transmission between the electric motor and the at least one hydraulic pump can be interrupted.

4. The truck-mounted concrete pump according to claim 1, wherein the power take-off of the transfer gearbox is an engine-dependent power take-off which is connected directly to a crankshaft of the travelling-drive motor.

5. The truck-mounted concrete pump according to claim 1, wherein the electric motor and the at least one hydraulic pump are located on the same side of the branching gearbox.

6. The truck-mounted concrete pump according to claim 1, wherein the electric motor and the at least one hydraulic pump are located on opposite sides of the branching gearbox.

7. The truck-mounted concrete pump according to claim 1, wherein the electric motor has an electrical output of at least 100 kW.

8. The truck-mounted concrete pump according to claim 1, wherein the at least one hydraulic pump is mechanically coupled either exclusively with the electric motor or exclusively with the travelling-drive motor.

9. The truck-mounted concrete pump according to claim 1, wherein the electric motor can be fed with electricity by way of a mains connection of the truck-mounted concrete pump.

10. The truck-mounted concrete pump according to claim 9, wherein the mains connection comprises one or more connection points for one or more parallel power supply lines, wherein the connection points are designed for identical or different continuous load values.
